(19) United States
(12) Patent Application Publication
(10) Pub. No.: US 2021/0261888 A1
(43) Pub. Date: Aug. 26, 2021

(54) DIATOMACEOUS EARTH CLEANING SYSTEM AND METHOD

(71) Applicant: Aguiar Ag Group, Inc., Prairie Village, KS (US)

(72) Inventors: Janelle Jackman, Shawnee, KS (US); Daniel Fenske, Valparaiso, IN (US); Stacia Taylor, Overland Park, KS (US); Dennis J. Aguiar, Prairie Village, KS (US)

(21) Appl. No.: 17/178,632

(22) Filed: Feb. 18, 2021

Related U.S. Application Data
(60) Provisional application No. 62/980,643, filed on Feb. 24, 2020.

(51) Int. Cl. C11D 7/20; C11D 17/00; C11D 11/00; C11D 3/50

(52) U.S. Cl. CPC C11D 7/20; C11D 17/003; C11D 3/50; C11D 11/0082; C11D 11/0017

(57) ABSTRACT

A cleaning system of the present invention uses diatomaceous earth as a base material in a cleaning and spot-removing compound. A cleaning and spot removing method includes the steps of either pre-mixing a powder form of the compound with water, or applying the powder form of the compound to a dampened surface to be cleaned to form a paste. The paste is allowed to dry for vacuuming or brushing away.

### CROSS-REFERENCE TO RELATED APPLICATION

This application claims priority in U.S. Provisional Patent Application No. 62/980,643, filed Feb. 24, 2020, which is incorporated herein by reference.

### BACKGROUND OF THE INVENTION

### 1. Field of the Invention

The present invention relates generally to cleaning products and procedures, and in particular to a cleaning system and method for removing pet and other stains from carpet, upholstery and other surfaces.

### 2. Description of the Related Art

A wide range of cleaning and maintenance products are available for various applications. For example, pet ownership typically involves maintenance and cleaning, particularly in residential accommodations of indoor dogs and cats. However, heretofore there has not been available a system or method for cleaning, especially pet stains, with the advantages and features of the present invention.

### SUMMARY OF THE INVENTION

The cleaning system of the present invention uses diatomaceous earth as a base material in a cleaning and spot-removing compound. The cleaning and spot removing method begins by applying a powder form of the compound to a dampened surface to be cleaned, allowing it to dry, and vacuuming or brushing it away. Additional applications for diatomaceous earth include filter media, lowering acidity in chlorinated pools and cleaning water for animal consumption.

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right, and left refer to the invention as orientated in the view being referred to. The words “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

### II. Detailed Description of the Preferred Embodiment

In the practice of the present invention, diatomaceous earth, or another substance with similar, desirable characteristics, is applied to a dampened surface. Without limitation, the surface to be cleaned can comprise carpet, upholstery, fabric and other materials. The cleaning composition dries to a powder form, which can be vacuumed or brushed away. Pet and other stains are generally removed by this process, which can be repeated as necessary.

In addition to providing an effective cleaner and stain remover, other advantages and applications of diatomaceous earth include: environmental sustainability; high-efficiency absorbency; reducing hazards from spilled oils and other liquids; and ubiquitous availability. Moreover, it combines effectively with other cleaners, solvents, fragrances. It can be diluted with water for optimizing its concentration in liquid form. Still further, food grade diatomaceous earth provides nutritional and digestive benefits without toxicity to animals.

### III. Conclusion

It is to be understood that the invention can be embodied in various forms and is not to be limited to the examples specifically discussed above. The range of components and configurations which can be utilized in the practice of the present invention is virtually unlimited.

Having thus described the invention, what is claimed as new and desired to be secured by Letters Patent is:

1. A diatomaceous earth carpet or fabric cleaning composition comprising:
a diatomaceous earth base; and
said diatomaceous earth base being configured for: mixing with water; applying to a staining substance on carpet or fabric; drying to a powder form; and removing from the carpet or fabric with the staining substance.

2. The cleaning composition according to claim 1, which includes a detergent additive.

3. The cleaning composition according to claim one, which includes a solvent additive.

4. The cleaning composition according to claim 1, which includes a fragrance additive.

5. A method of cleaning a staining substance from carpet or fabric, which method comprises the steps of:
providing a diatomaceous earth base;
mixing said diatomaceous earth base with water to form a paste;
drying said paste to a powder form; and
removing said powder form base from said carpet or fabric.

6. The method according to claim 5, which includes the additional steps of:
dampening the fabric or carpet to be cleaned; and
applying said diatomaceous earth base as a powder to said dampened fabric or carpet.

7. The method according to claim 5, which includes the additional steps of:
pre-mixing said diatomaceous earth base with water to form said paste; and
applying said paste to said fabric or carpet to be cleaned.

8. The method according to claim 5, which includes the additional step of brushing said powder form paste from said carpet or fabric.

9. The method according to claim 5, which includes the additional step of:
vacuuming said powder form paste from said carpet or fabric.

10. The method according to claim 5, which includes the additional step of mixing said diatomaceous earth base with a fragrance.
